(19) United States
(12) Patent Application Publication
(10) Pub. No.: US 2011/0274936 A1
(43) Pub. Date: Nov. 10, 2011

(54) FLUORINE- AND SILICON-CONTAINING TREATMENT AGENT FOR CONCRETES

(75) Inventors: Teruyuki Fukuda, Osaka (JP); Shinichi Minami, Osaka (JP); Peter Cheshire Hupfield, Trevaughan (GB); Samantha Reed, Cardiff (GB); Janet Smith, Swartz Creek, MI (US)

(73) Assignees: Dow Corning Corporation, Midland, MI (US); Daikin Industries, Ltd., Osaka (JP)

(21) Appl. No.: 13/123,754

(22) PCT Filed: Oct. 9, 2009
(86) PCT No.: PCT/JP2009/067958

§ 371 Date: Jun. 16, 2011

Related U.S. Application Data
(60) Provisional application No. 61/104,827, filed on Oct. 13, 2008.

(51) Int. Cl. B32B 13/12; C08L 83/04; C08G 77/04

(52) U.S. Cl. 428/447; 528/26; 524/588

(57) ABSTRACT

The present invention provides a surface treatment agent comprising a fluorine-containing polymer having repeating units derived from a monomer comprising a fluorine-containing monomer, wherein the fluorine-containing polymer has a silicone moiety possessed by a mercapto group-containing silicone. When a porous substrate is treated under drying at normal temperature, the surface treatment agent comprising the fluorine-containing acrylate polymer can impart the excellent water- and oil-repellency and soil resistance to the porous substrate.

### CROSS REFERENCE TO RELATED APPLICATIONS

This application has priority from U.S. Application No. 61/104,827 filed Oct. 13, 2008, disclosures of which are incorporated herein by reference.

### TECHNICAL FIELD

This invention relates to a surface treatment agent imparting excellent water repellency, oil repellency and soil resistance, to a porous substrate such as a concrete, without significantly changing the appearance of the substrate and relates to treatment with said surface treatment agent.

### BACKGROUND ARTS

Hitherto, a water- and oil-repellent composition comprising a mixture of a perfluoroalkyl compound imparting the water- and oil-repellency and a silicone compound imparting the water resistance has been widely used, in order to impart the water- and oil-repellency and the water resistance to a porous substrate such as concrete (for example, JP-A-06-172677, U.S. Pat. No. 5,399,191).

A repellent agent for textile has been converted to the fluoroacrylate polymer used for the conventional concrete surface treatment agents. The fluoroacrylate polymer always has a pendent fluoroalkyl group having at least 8 carbon atoms. The fluoroacrylate polymer containing a pendent fluoroalkyl group having at least 8 carbon atoms has the problems that, in the case of emulsion polymerization, a large amount of used emulsifier is necessary and a type of used emulsifier is limited, and that an arbitrary solvent should be used due to poor compatibility of a fluorine-containing monomer with a fluorine-free monomer. It is necessary to forcibly dry the repellent agent at more than 100° C. in order to give sufficient effects such as excellent water repellency, but it is substantially impossible to forcibly heat the concrete to dry surface treatment agent. The surface treatment agent should impart the sufficient effects under drying at a normal temperature.

Recent study results (EPA Report “PRELIMINARY RISK ASSESSMENT OF THE DEVELOPMENTAL TOXICITY ASSOCIATED WITH EXPOSURE TO PERFLUOROOCTANOIC ACID AND ITS SALTS” (http://www.epa.gov/opptintr/pfoa/pfoara.pdf)) and the like clarify that a PFOA (perfluorooctanoic acid) doubtfully has a potential risk of environmental load. EPA (Environmental Protection Agency of USA) announced on Apr. 14, 2003 that the EPA intensifies the scientific investigation.

On the other hand, Federal Register (FR Vol. 68, No. 73/Apr. 16, 2003 [FRL-2303-8]) (http://www.epa.gov/opptintr/pfoa/pfoafr.pdf),

EPA Environmental News for release Monday April, 2003 “EPA INTENSIFIES SCIENTIFIC INVESTIGATION OF A CHEMICAL PROCESSING AID” (http://www.epa.gov/opptintr/pfoa/pfoaprs.pdf), and
EPA OPPT FACT SHEET Apr. 14, 2003 (http://www.epa.gov/opptintr/pfoa/pfoafacts.pdf) announced that a fluorinated “telomer” may metabolize or decompose to PFOA. It is also announced that the telomer is used in a large number of commercial products including fire fighting foams, care products and cleaning products as well as soil, stain and grease resistant coating on carpets, textiles, paper, and leather.

### PROBLEMS TO BE SOLVED BY THE INVENTION

An object of the present invention is to provide a concrete surface treatment agent comprising a fluorine-containing acrylate polymer which can impart excellent water- and oil-repellency and soil resistance to a substrate even under drying at normal temperature, when a concrete is treated with said treatment agent.

### SUMMARY OF THE INVENTION

The present inventors discovered that the above-mentioned object can be achieved by a polymer which is formed from a monomer comprising a fluorine-containing monomer and which is polymerized in the presence of a mercapto group-containing silicone.

The present invention provides a surface treatment agent for concrete, comprising a fluorine-containing polymer comprising:

(A) a monomer which comprises;

(a) a fluorine-containing monomer of the formula:

CH₂═C(—X)—C(═O)—O—Y—Rf (I)

wherein
X is a hydrogen atom, an linear or branched alkyl group having 1 to 21 carbon atoms, a halogen atom, a CFX¹X² group (wherein X¹ and X² is a hydrogen atom or a halogen atom), a cyano group, a linear or branched fluoroalkyl group having 1 to 21 carbon atoms, a substituted or unsubstituted benzyl group, or a substituted or unsubstituted phenyl group,
Y is a direct bond, or an unsubstituted or substituted hydrocarbon group having 1 to 10 carbon atoms, and
Rf is a linear or branched fluoroalkyl group having 1 to 21 carbon atoms, and
   (B) a mercapto group-containing silicone.

The present invention provides a fluorine-containing polymer comprising repeating units derived from a monomer comprising a fluorine-containing monomer, wherein the fluorine-containing polymer has a silicone moiety possessed by a mercapto group-containing silicone.

The present invention also provides a method of producing a fluorine-containing polymer comprising repeating units derived from a monomer comprising a fluorine-containing monomer, wherein the method comprises polymerizing the monomer in the presence of a mercapto group-containing silicone to give the fluorine-containing polymer.

### EFFECTS OF THE INVENTION

According to the present invention, when a porous substrate is treated under drying at normal temperature (20° C. to 25° C.), the water- and oil-repellent agent comprising the fluorine-containing acrylate polymer can impart the excellent water- and oil-repellency and soil resistance to the porous substrate.

### MODE FOR CARRYING OUT THE INVENTION

In the present invention, the monomer (A) forming the fluorine-containing polymer comprises:

(a) a fluorine-containing monomer,
(b) optionally present, a fluorine-free monomer other than a crosslinkable monomer, and
(c) optionally present, a crosslinkable monomer.

The fluorine-containing polymer may be a homopolymer formed from one monomer or a copolymer formed from at least two monomers.

The homopolymer has the repeating units derived from the fluorine-containing monomer (a). The copolymer may has the repeating units derived from at least two fluorine-containing monomers (a), or may have, in addition to the repeating units derived from the fluorine-containing monomer (a), the repeating units derived from the fluorine-free monomer (b) and optionally the crosslinkable monomer (c).

The fluorine-containing polymer can be prepared by polymerizing the monomer (A) in the presence of the mercapto group-containing silicone (B).

The fluorine-containing polymer constituting the surface treatment agent of the present invention comprises:

(a) the fluorine-containing monomer, and
optionally (b) the fluorine-free monomer other than the crosslinkable monomer, and
optionally (c) the crosslinkable monomer.

The fluorine-containing monomer (a) is a compound of the formula:

CH₂═C(—X)—C(═O)—O—Y—Rf (I)

wherein X is a hydrogen atom, an linear or branched alkyl group having 1 to 21 carbon atoms, a halogen atom (such as a fluorine atom, a chlorine atom, a bromine atom, a iodine atom), a CFX¹X² group (wherein X¹ and X² is a hydrogen atom, a fluorine atom, a chlorine atom, a bromine atom or a iodine atom), a cyano group, a linear or branched fluoroalkyl group having 1 to 21 carbon atoms, a substituted or unsubstituted benzyl group, or a substituted or unsubstituted phenyl group,
Y is a direct bond, or an unsubstituted or substituted hydrocarbon group having 1 to 10 carbon atoms, preferably an aliphatic group having 1 to 10 carbon atoms, an aromatic or cycloaliphatic group having 6 to 10 carbon atoms,
a —CH₂CH₂N(R¹)SO₂— group (wherein R¹ is an alkyl group having 1 to 4 carbon atoms) or
—CH₂CH(OY¹)CH₂— group (wherein Y¹ is a hydrogen atom or an acetyl group),
Rf is a linear or branched fluoroalkyl group having 1 to 21 carbon atoms.

The alpha-position of the fluorine-containing monomer may be substituted with a halogen atom or the like. Accordingly, in the formula (I), X may be an linear or branched alkyl group having 2 to 21 carbon atoms, a fluorine atom, a chlorine atom, a bromine atom, a iodine atom, a CFX¹X² group (wherein X¹ and X² is a hydrogen atom, a fluorine atom, a chlorine atom, a bromine atom or a iodine atom), a cyano group, a linear or branched fluoroalkyl group having 1 to 21 carbon atoms, a substituted or unsubstituted benzyl group, or a substituted or unsubstituted phenyl group.

In the formula (I), the Rf group is preferably a perfluoroalkyl group. The carbon number of the Rf group is from 1 to 21, for example, from 1 to 6, particularly from 4 to 6, especially 6.

Y is preferably an aliphatic group having 1 to 10 carbon atoms, an aromatic group or cycloaliphatic group having 6 to 10 carbon atoms, a —CH₂CH₂N(R¹)SO₂— group (R¹ is an alkyl group having 1 to 4 carbon atoms) or a —CH₂CH(OY¹)CH₂— group (Y¹ is a hydrogen atom or an acetyl group). The aliphatic group is preferably an alkylene group (particularly the carbon number is from 1 to 4, for example, 1 or 2). The aromatic group and cycloaliphatic group may be substituted or unsubstituted.

The examples of the fluorine-containing monomer (a) are as follows:

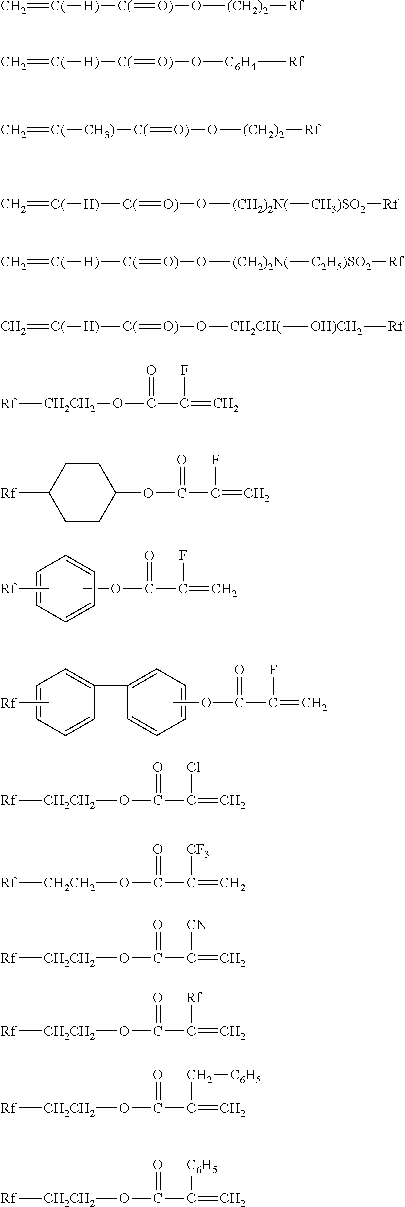

wherein Rf is a linear or branched fluoroalkyl group having 1 to 21 carbon atoms.

The fluorine-containing polymer may have the repeating units derived from the fluorine-free monomer (b). The fluorine-free monomer (b) is other than the crosslinkable monomer (c). The monomer (b) is preferably a fluorine-free monomer having a carbon-carbon double bond. The monomer (b) is preferably a vinyl monomer which is free from fluorine. The fluorine-free monomer (b) is generally a compound having one carbon-carbon double bond. Preferable examples of the fluorine-free monomer (b) include, for example, ethylene, vinyl acetate, vinyl halide such as vinyl chloride, vinylidene halide such as vinylidene chloride, acrylonitrile, styrene, polyethyleneglycol (meth)acrylate, polypropyleneglycol (meth)acrylate, methoxypolyethyleneglycol (meth)acrylate, methoxypolypropyleneglycol (meth)acrylate, vinyl alkyl ether. The fluorine-free monomer (b) is not limited to these examples. The fluorine-free monomer (b) may contain vinyl halide and/or vinylidene halide.

The fluorine-free monomer (b) may be a (meth)acrylate ester having an alkyl group. The number of carbon atoms of the alkyl group may be from 1 to 30, for example, from 6 to 30, e.g., from 10 to 30. For example, the fluorine-free monomer (b) may be acrylates of the general formula:

CH₂═CA¹COOA²

wherein A¹ is a hydrogen atom, a methyl group, or a halogen atom (for example, a chlorine atom, a bromine atom and a iodine atom) other than a fluorine atom, and A² is an alkyl group represented by CₙH₂ₙ₊₁ (n=1 to 30).

The fluorine-free monomer (b) preferably includes a combination of (i) the (meth)acrylate ester and (ii) vinyl halide and/or vinylidene halide in a weight ratio [(i)/(ii)] of 10:90 to 90:10, for example, 15:85 to 60:40, particularly 20:80 to 40:60.

The fluorine-containing polymer may contain the repeating units derived from the crosslinkable monomer (c). The crosslinkable monomer (c) may be a fluorine-free vinyl monomer having at least two reactive groups and/or carbon-carbon atoms. The crosslinkable monomer (c) may be a compound having at least two carbon-carbon double bonds, or a compound having at least one carbon-carbon double bond and at least one reactive group. Examples of the reactive group include a hydroxyl group, an epoxy group, a chloromethyl group, a blocked isocyanate group, an amino group and a carboxyl group.

Examples of the crosslinkable monomer (c) include diacetoneacrylamide, (meth)acrylamide, N-methylolacrylamide, hydroxymethyl (meth)acrylate, hydroxyethyl (meth)acrylate, 3-chloro-2-hydroxypropyl (meth)acrylate, N,N-dimethylaminoethyl (meth)acrylate, N,N-diethylaminoethyl (meth)acrylate, butadiene, chloroprene, isoprene and glycidyl (meth)acrylate, to which the crosslinkable monomer is not limited.

The reactive group in the crosslinkable monomer (c) is preferably the hydroxyl group, the epoxy group or the combination of the hydroxyl group and the epoxy group. When the crosslinkable monomer (c) has the combination of the hydroxyl group and the epoxy group, a weight ratio of the monomer having the hydroxyl group to the monomer having the epoxy group is preferably 10:90 to 90:10, for example, 85:15 to 40:60, particularly 80:20 to 60:40.

The copolymerization with the monomer (b) and/or the monomer (c) can optionally improve various properties such as water- and oil-repellency and soil resistance; durability of said repellency and resistance; solubility in solvent.

In the fluorine-containing polymer,

the amount of the fluorine-free monomer (b) may be from 0.1 to 100 parts by weight, for example, from 0.1 to 50 parts by weight, and
the amount of the crosslinkable monomer (c) may be at most 50 parts by weight, for example, at most 20 parts by weight, particularly, from 0.1 to 15 parts by weight, based on 100 parts by weight of the fluorine-containing monomer (a).

The mercapto group-containing silicone (B) is a siloxane compound having a silicone portion having at least two siloxane linkages and at least one (particularly one) mercapto group. The mercapto group-containing silicone (B) acts as a chain transfer agent. In the polymerization reaction, a hydrogen (H) radical is generate from a —SH group, and a sulfur (S) atom bonding to a silicone portion can bond to the fluorine-containing polymer.

The mercapto group-containing silicone (B) may be, for example, of the formula:

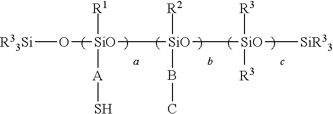

wherein R¹ is a methyl group, a methoxy group, a phenyl group, or a hydroxyl group,
R² is a methyl group, a methoxy group, a phenyl group, or a hydroxyl group,
R³ is a methyl group, a methoxy group, a phenyl group, or a hydroxyl group,
A is a divalent saturated hydrocarbon group having 1-10 carbon atoms which may be interrupted with one or two ether linkages,
B is a divalent saturated hydrocarbon group having 1-10 carbon atoms which may be interrupted with one or two ether linkages,
C is an amino group, a hydroxyl group, an epoxy group or a carboxyl group,
a, b, and c are integers showing the number of repeat units, a is from 1 to 4000, for example, 2 to 2000, b is from 0 to 1000, preferably from 1 to 800, and c is from 0 to 1000, preferably from 1 to 800.

Examples of A and B are alkylene group having 1-10, particularly 2-6 carbon atoms.

Specified examples of the mercapto group-containing silicone (B) include the following:

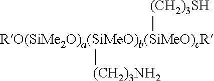

where;

a is 0-4000, alternatively 1 to 1000, alternatively 2 to 400,

b is 0-1000, alternatively 1 to 100, alternatively 2 to 50,

c is 1-1000, alternatively 2 to 100, alternatively 3 to 50;

and R′ is H, an alkyl group having 1 to 40 carbon atoms, or Me₃Si.

The mercapto group-containing silicone of this specified example can be prepared by any technique known in the art for preparation of organopolysiloxane terpolymers containing amino and/or mercapto functional groups. Typically, the mercapto group-containing silicone are prepared via a condensation polymerization reaction of an amino functional alkoxy silane, a mercapto functional silane monomer, and organopolysiloxane having alkoxy or silanol termination as illustrated by the following general reaction scheme.

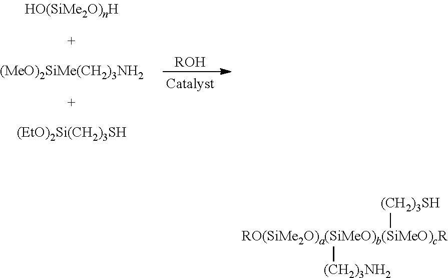

wherein R is an alkyl group having 1 to 40 carbon atoms, and Me is a methyl group.

Condensation organopolysiloxanes are well known in the art and are typically catalyzed by the addition of a strong base, such as an alkaline metal hydroxide or a tin compound. Alternatively co-polymerization of the functionalized cyclosiloxanes could be used.

The fluorine-containing polymer of the monomer (A) and the organopolysiloxane (B) may be prepared by any reaction process known in the art to effect polymerisation of such monomers. Preferably, the fluorine-containing polymer may be prepared by reacting the monomer (A) in the presence of the organopolysiloxane (B), via a polymerization reaction, preferably a free radical polymerisation reaction.

The fluorine-containing polymer can contain various ratios of the monomer (A) and the organopolysiloxane (B), as controlled by the amount of each of components (A) and (B). The fluorine-containing polymer may contain 5 to 99.9% by weight, preferably 10 to 95% by weight of the monomer (A), and 0.1 to 95% by weight, preferably 5 to 90% by weight of the organopolysiloxane (B) with the proviso that sum of the wt % of (A) and (B) equals 100%.

The fluorine-containing polymer may have a weight-average molecular weight of 2,000 to 5,000,000, particularly 3,000 to 5,000,000, especially 10,000 to 1,000,000. The weight-average molecular weight (in terms of polystyrene) of the fluorine-containing polymer can be determined by GPC (Gel Permeation Chromatography).

The fluorine-containing polymer can be produced by any polymerization method. The polymerization method includes, for example, solution polymerization and emulsion polymerization.

In the solution polymerization, there can be used a method of dissolving the monomer(s) into an organic solvent in the presence of a polymerization initiator, replacing the atmosphere by nitrogen, and stirring the mixture with heating, for example, at the temperature within the range from 30° C. to 120° C. for 1 hour to 10 hours. Examples of the polymerization initiator include azobisisobutyronitrile, benzoyl peroxide, di-tert-butyl peroxide, lauryl peroxide, cumene hydroperoxide, t-butyl peroxypivalate and diisopropyl peroxydicarbonate. The polymerization initiator may be used in the amount within the range from 0.01 to 20 parts by weight, for example, from 0.01 to 10 parts by weight, based on 100 parts by weight of the monomers.

The organic solvent is inert to the monomer and dissolves the monomer, and examples thereof include acetone, chloroform, HCFC225, isopropyl alcohol, pentane, hexane, heptane, octane, cyclohexane, benzene, toluene, xylene, petroleum ether, tetrahydrofuran, 1,4-dioxane, methyl ethyl ketone, methyl isobutyl ketone, ethyl acetate, butyl acetate, 1,1,2,2-tetrachloroethane, 1,1,1-trichloroethane, trichloroethylene, perchloroethylene, tetrachlorodifluoroethane and trichlorotrifluoroethane. The organic solvent may be used in the amount within the range from 50 to 2,000 parts by weight, for example, from 50 to 1,000 parts by weight, based on 100 parts by weight of total of the monomers.

In the emulsion polymerization, there can be used a method of emulsifying monomers in water in the presence of a polymerization initiator and an emulsifying agent, replacing the atmosphere by nitrogen, and polymerizing with stirring, for example, at the temperature within the range from 50° C. to 80° C. for 1 hour to 10 hours. As the polymerization initiator, for example, water-soluble initiators (e.g., benzoyl peroxide, lauroyl peroxide, t-butyl perbenzoate, 1-hydroxycyclohexyl hydroperoxide, 3-carboxypropionyl peroxide, acetyl peroxide, azobisisobutylamidine dihydrochloride, azobisisobutyronitrile, sodium peroxide, potassium persulfate and ammonium persulfate) and oil-soluble initiators (e.g., azobisisobutyronitrile, benzoyl peroxide, di-tert-butyl peroxide, lauryl peroxide, cumene hydroperoxide, t-butyl peroxypivalate and diisopropyl peroxydicarbonate) are used. The polymerization initiator may be used in the amount within the range from 0.01 to 10 parts by weight based on 100 parts by weight of the monomers.

In order to obtain a polymer dispersion in water, which is superior in storage stability, it is desirable that the monomers are dispersed in water by using an emulsifying device capable of applying a strong shearing energy (e.g., a high-pressure homogenizer and an ultrasonic homogenizer) and then polymerized with using the oil-soluble polymerization initiator. As the emulsifying agent, various emulsifying agents such as an anionic emulsifying agent, a cationic emulsifying agent and a nonionic emulsifying agent can be used in the amount within the range from 0.5 to 20 parts by weight based on 100 parts by weight of the monomers. When the monomers are not completely compatibilized, a compatibilizing agent capable of sufficiently compatibilizing them (e.g., a water-soluble organic solvent and a low-molecular weight monomer) is preferably added to these monomers. By the addition of the compatibilizing agent, the emulsifiability and polymerizability can be improved.

Examples of the water-soluble organic solvent include acetone, methyl ethyl ketone, ethyl acetate, propylene glycol, dipropylene glycol monomethyl ether, dipropylene glycol, tripropylene glycol and ethanol. The water-soluble organic solvent may be used in the amount within the range from 1 to 50 parts by weight, e.g., from 10 to 40 parts by weight, based on 100 parts by weight of water. Examples of the low-molecular weight monomer are methyl methacrylate, glycidyl methacrylate, 2,2,2-trifluoroethyl methacrylate. The low-molecular weight monomer may be used in the amount within the range from 1 to 50 parts by weight, e.g., from 10 to 40 parts by weight, based on 100 parts by weight of total of monomers.

The treatment agent of the present invention may contain (3) an additive, in addition to the fluorine-containing polymer (1) and the liquid medium (2).

Examples of the additive (3) include a silicon-containing compound, a wax and an acrylic emulsion.

The silicon-containing compound is preferably a compound having at least one siloxane linkage.

The silicon-containing compound includes, for example, an alkyl silicate and a siliconate.

The alkyl silicate may be a compound represented by the following general formula (I):

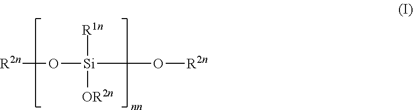

wherein R¹ⁿ is an alkyl group containing 1 to 18 carbon atoms and, when nn is at least 2 or more, the R¹ⁿ groups may be the same or different; R²ⁿ is a hydrogen atom or an alkyl group containing 1 to 5 carbon atoms and, when nn is 2 or more, the R²ⁿ groups may be the same or different; and nn is an integer of 1 to 20.

The alkyl group containing 1 to 18 carbon atoms as represented by R¹ⁿ is not particularly restricted but includes, among others, a methyl group, an ethyl group, a propyl group, a butyl group, a pentyl group, a hexyl group, a heptyl group, an octyl group, a nonyl group, a decyl group, an undecyl group, a dodecyl group, a tridecyl group, a tetradecyl group, a pentadecyl group, a hexadecyl group, a heptadecyl group and an octadecyl group. These may be straight-chained or branched.

The alkyl group containing 1 to 5 carbon atoms as represented by R²ⁿ is not particularly restricted but includes, among others, methyl, ethyl, propyl, butyl and pentyl. These may be straight-chained or branched.

The symbol nn represents an integer of 1 to 20, for example an integer of 1 to 10.

As said silicon-containing compound, there may more specifically be mentioned, among others, methyltrimethoxysilane, ethyltrimethoxysilane, propyltrimethoxysilane, butyltrimethoxysilane, pentyltrimethoxysilane, hexyltrimethoxysilane, heptyltrimethoxysilane, octyltrimethoxysilane, nonyltrimethoxysilane, decyltrimethoxysilane, undecyltrimethoxysilane, dodecyltrimethoxysilane, tridecyltrimethoxysilane, tetradecyltrimethoxysilane, pentadecyltrimethoxysilane, hexadecyltrimethoxysilane, heptadecyltrimethoxysilane, octadecyltrimethoxysilane, methyltriethoxysilane, ethyltriethoxysilane, propyltriethoxysilane, butyltriethoxysilane, pentyltriethoxysilane, hexyltriethoxysilane, heptyltriethoxysilane, octyltriethoxysilane, nonyltriethoxysilane, decyltriethoxysilane, undecyltriethoxysilane, dodecyltriethoxysilane, tridecyltriethoxysilane, tetradecyltriethoxysilane, pentadecyltriethoxysilane, hexadecyltriethoxysilane, heptadecyltriethoxysilane, octadecyltriethoxysilane and so forth. Among them, methyltrimethoxysilane, methyltriethoxysilane, hexyltriethoxysilane and octyltriethoxysilane are preferred.

The above-mentioned silicon-containing compounds may be used also in their dimer form as the silicon-containing compound in the present invention. As such, there may be mentioned those of general formula (I) in which nn is 2 or 3, for instance. Furthermore, those in which nn is up to 20 may be used as well.

The siliconate (particularly alkyl siliconate) is, for example, of the formula:

R¹ₐSi(OR²)_{b}(OM)_{c}.

wherein a is an integer of at least 0 (preferably 1),
b is an integer of at least 0 (preferably 2),
c is an integer of at least 1 (preferably 1) provided that the total of a, b and c is 4,
R¹ each is, the same or different, a hydrocarbon group having 1 to 18 carbon atoms,
R² each is, the same or different, a hydrogen atom or a hydrocarbon group having 1 to 18 carbon atoms, and
M each is, the same or different, an alkaline metal.

The hydrocarbon group may be, for example, an aliphatic hydrocarbon group (for example, an alkyl group), a cycloaliphatic hydrocarbon group, an aromatic hydrocarbon group or an araliphatic hydrocarbon group.

R¹ includes, for example, a methyl group, an ethyl group, a propyl group, an isopropyl group, a n-butyl group, an isobutyl group, a t-butyl group, a n-pentyl group, an isopentyl group, a neopentyl group, a t-pentyl group, a n-hexyl group, a n-heptyl group, a n-octyl group, an isooctyl group, a 2,2,4-trimethylpentyl group, a n-nonyl group, a n-decyl group, a n-dodecyl group, a n-octadecyl group, a cyclopentyl group, a cyclohexyl group, a cycloheptyl group, a methylcyclohexyl group, a phenyl group, naphtyl group, an anthryl group, a phenanthryl group, a tolyl group, a xylyl group, an ethylphenyl group, a benzyl group and a phenylethyl group. Among them, the methyl group, the ethyl group and the propyl group are preferable, and the methyl group is particularly preferable.

R² includes the hydrogen group, and the same examples of groups mentioned as in R¹. Among them, the hydrogen group, the methyl group and the ethyl group are preferable, and the hydrogen group is particularly preferable.

M includes Li, Na and K. Particularly Na is preferable.

Specific examples of alkyl siliconate include sodium methyl siliconate [CH₃Si(OH)₂(ONa)] and potassium ethyl siliconate [C₂H₅Si(OH)₂(OK)].

The amount of the additive (3) may be from 0 to 200 parts by weight, for example, from 0 to 50 parts by weight, e.g., from 0.1 to 50 parts by weight, based on 100 parts by weight of the fluorine-containing polymer (1).

The treatment agent may contain another water repellent agent, another oil repellent agent, a drying speed controlling agent, a crosslinking agent, a film forming agent, a compatibilizing agent, a surfactant, an antifreezing agent, a viscosity-adjusting agent, an ultraviolet absorbing agent, an antioxidant, a pH adjuster, a defoaming agent, a slippage controlling agent, antistatic agent, a hydrophilizing agent, an antibacterial agent, an antiseptic agent, an insecticide agent, an aromatic agent, a flame retardant, a color tone controlling agent, etc. in addition to the above-mentioned components (1)-(3) according to necessity.

The surface treatment agent of the present invention is preferably in the form of a solution, an emulsion or an aerosol. The surface treatment agent generally comprises the fluorine-containing polymer and a medium (particularly a liquid medium, for example, an organic solvent and/or water). The concentration of the fluorine-containing polymer in the surface treatment agent may be, for example, from 0.1 to 50% by weight.

The surface treatment agent can be applied to a substrate to be treated by a know procedure. The application of the surface treatment agent can be conducted by immersion, spraying and coating. Usually, the surface treatment agent is diluted with an organic solvent or water, is adhered to surfaces of the substrate by a well-known procedure such as an immersion coating, a spray coating and a foam coating, and is dried.

The term “treatment” means that the treatment agent is applied to the substrate by immersion, spray, coating or the like. The fluorine-containing polymer which is an active component of the treatment agent can penetrate the internal of the substrate or can adhere on the surface of the substrate by the treatment.

### EXAMPLES

The following Preparative Examples and Examples further illustrate the present invention in detail but are not to be construed to limit the scope thereof.

### Synthetic Example 1

### Synthesis of Mercapto Group-Containing Silicone (Siloxane A)

Into a three necked round bottomed flask fitted with a condenser, overhead stirrer and thermocouple were charged first silanol-terminated polydimethylsiloxane (323 g, Mn: about 900), second silanol-terminated polydimethylsiloxane (380 g, Mn: about 300), mercaptopropylmethyldimethoxysilane (230 g), aminopropylmethyldiethoxysilane (27 g), trimethylethoxysilane (42 g), barium hydroxide (0.62 g) and sodium orthophosphate (0.25 g). The reaction mixture was heated to 75° C. and held at this temperature for three hours. Then the volatiles were removed under reduced pressure (200 mbar) at 75° C. for four hours to yield an aminomercaptosiloxane (Siloxane A).

The physical and structural properties of the aminomercaptosiloxane are described in the table below:

| | | | | | % | |
|---|---|---|---|---|---|---|
| | | Vis- | | | (SiMe₃ | % (OR terminal |
| | | cosity | % N | % SH | terminal | group or SiOH |
| | Mn | (cSt) | (w/w) | (w/w) | group) | terminal group) |
| Siloxane A | 4396 | 74 | 0.26 | 4.10 | 9 | 91 |

### Preparative Example 1

### Preparation of C6 Hybrid Polymer Emulsion

A mixture of CF₃CF₂—(CF₂CF₂)₂—CH₂CH₂OCOC(CH₃)═CH₂ [Rf(C6) methacrylate] (9.2 g), stearyl acrylate (StA) (1.15 g), glycerol methacrylate (GLM) (0.22 g), glycidyl methacrylate (GMA) (0.07 g), an aminomercaptosiloxane prepared in Synthetic Example 1 (Siloxane A) (1.42 g), pure water (23.3 g), dipropylene glycol (4.25 g), sodium polyoxyethylene(2)lauryl ether sulfate (0.76 g), sorbitan monopalmitate (0.13 g) and polyoxyethylene(100) hardened castor oil derivative (0.635 g) were heated at 60° C. and previously emulsified by a homomixer. The mixture was emulsified by an ultrasonic homogenizer to give a monomer emulsion having an average particle size of about 200 nm (a dynamic light scattering method). The monomer emulsion was transferred to an autoclave, the atmosphere of the autoclave was replaced with a nitrogen gas, and then vinyl chloride (3.36 g) was injected. Then, 2,2′-azobis(2-amidinopropane) dihydrochloride (0.18 g) was added and the reaction was conducted at 60° C. for 5 hours to give an aqueous emulsion of a polymer. The emulsion was diluted with water to have a solid content of 20% by weight, wherein the solid content was measured by an evaporation residue remaining after the emulsion was heated at 130° C. at 2 hours.

### Comparative Preparative Example 1

### C6 Non-Hybrid

In the same manner as in Preparative Example 1, an emulsion was prepared except that the aminomercaptosiloxane was changed to n-dodecylmercaptane (0.23 g).

### Comparative Preparative Example 2

### C8 Non-Hybrid

In the same manner as in Preparative Example 1, an emulsion was prepared except that CF₃CF₂—(CF₂CF₂)₂—CH₂CH₂OCOC(CH₃)═CH₂ [Rf(C6) methacrylate] was changed to CF₃CF₂—(CF₂CF₂)₃—CH₂CH₂OCOCH═CH₂ [Rf(C8) acrylate] (9.2 g) and the aminomercaptosiloxane was changed to n-dodecylmercaptane (0.23 g).

### Example 1 and Comparative Examples 1 and 2

The polymer emulsion prepared in Preparative Example 1 was diluted with deionized water to give a solid content of 3% by weight (Example 1). The polymer emulsion prepared in each of Comparative Preparative Examples 1 and 2 was diluted with deionized water to give a solid content of 3% by weight (Comparative Examples 1 and 2). The diluted emulsion was uniformly coated on a concrete test piece at 200 g/m². Then, the concrete was dried at 20° C. for 24 hours and subjected to a soil resistance test.

The soil resistance test was as follows:

Droplets of a soil were put on a treated substrate, and droplets were left for 24 hours and wiped off with a paper towel. The evaluation was conducted according to the following criteria.

1: Deep stain, and broad oil droplet spread

2: Deep stain, and slight or no oil droplet spread

3: Medium stain, and no spread

4: Slight stain

5: No stain.

The results are shown in the following table.

| | Concrete panel | | | |
|---|---|---|---|---|
| | | | Comparative | Comparative |
| | | Preparative | Preparative | Preparative |
| | Untreated | Example 1 | Example 1 | Example 2 |
| Olive oil | 1 | 5 | 2 | 2 |
| Salad oil | 1 | 5 | 2 | 3 |
| Chili oil | 1 | 5 | 2 | 3 |
| Motor oil | 1 | 5 | 2 | 2 |
| Red wine | 1 | 5 | 4 | 4 |
| Coffee | 1 | 5 | 5 | 5 |
| Blue ink | 1 | 3 | 3 | 3 |
| Gargle | 1 | 4 | 3 | 4 |
| Total | 8 | 37 | 23 | 26 |

1. A surface treatment agent for concrete, comprising a fluorine-containing polymer comprising:
(A) a monomer which comprises;
(a) a fluorine-containing monomer of the formula:
CH₂═C(—X)—C(═O)—O—Y—Rf (I)
wherein
X is a hydrogen atom, an linear or branched alkyl group having 1 to 21 carbon atoms, a halogen atom, a CFX¹X² group (wherein X¹ and X² is a hydrogen atom or a halogen atom), a cyano group, a linear or branched fluoroalkyl group having 1 to 21 carbon atoms, a substituted or unsubstituted benzyl group, or a substituted or unsubstituted phenyl group,
Y is a direct bond, or an unsubstituted or substituted hydrocarbon group having 1 to 10 carbon atoms, and
Rf is a linear or branched fluoroalkyl group having 1 to 21 carbon atoms, and
(B) a mercapto group-containing silicone.

2. The surface treatment agent according to claim 1, wherein the monomer (A) further comprises:
(b) a fluorine-free monomer, and
(c) optionally present, a crosslinkable monomer,
in addition to (a) the fluorine-containing monomer.

3. The surface treatment agent according to claim 1 wherein the X group in the monomer (A) is a hydrogen atom or a methyl group.

4. The surface treatment agent according to claim 1 wherein the Y group in the monomer (A) is a direct bond,
an aliphatic group having 1 to 10 carbon atoms,
an aromatic or cycloaliphatic group having 6 to 10 carbon atoms,
a —CH₂CH₂N(R¹)SO₂— group,
wherein R¹ is an alkyl group having 1 to 4 carbon atoms, or —CH₂CH(OY¹)CH₂— group,
wherein Y¹ is a hydrogen atom or an acetyl group, and

5. The surface treatment agent according to claim 1 wherein the Rf group has 1 to 6 carbon atoms.

6. The surface treatment agent according to claim 1 wherein the Rf group is a perfluoroalkyl group.

7. The surface treatment agent according to claim 2, wherein the fluorine-free monomer (b) is acrylates of the general formula:
CH₂═CA¹COOA²
wherein A¹ is a hydrogen atom, a methyl group or a halogen atom other than a fluorine atom, and
A² is a hydrocarbon group having 1 to 30 carbon atoms, particularly an alkyl group represented by CₙH₂ₙ₊₁ wherein n is 1 to 30.

8. The surface treatment agent according to claim 2, wherein the crosslinkable monomer (c) is a monomer having at least two reactive groups, a monomer having least two carbon-carbon double bonds, or a monomer having at least one carbon-carbon double bond and at least one reactive group.

9. The surface treatment agent according to claim 1, wherein the mercapto group-containing silicone (B) has a silicone portion having at least two siloxane linkages and at least one mercapto group.

10. The surface treatment agent according to claim 1, wherein the mercapto group-containing silicone (B) is of the formula: 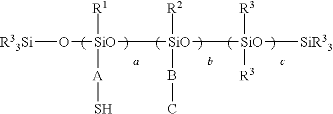
wherein R¹ is a methyl group, a methoxy group, a phenyl group, or a hydroxyl group,
R² is a methyl group, a methoxy group, a phenyl group, or a hydroxyl group,
R³ is a methyl group, a methoxy group, a phenyl group, or a hydroxyl group,
A is a divalent linear or branched saturated hydrocarbon group having 1-10 carbon atoms which may be interrupted with one or two ether linkages,
B is a divalent linear or branched saturated hydrocarbon group having 1-10 carbon atoms which may be interrupted with one or two ether linkages,
C is an amino group, a hydroxyl group, an epoxy group or a carboxyl group,
a, b, and c are integers showing the number of repeat units, a is from 1 to 4000, for example, 2 to 2000, b is from 0 to 1000, preferably from 1 to 800, and c is from 0 to 1000, preferably from 1 to 800.

11. The surface treatment agent according to claim 1, which further comprises a liquid medium.

12. A method of treating a substrate with the surface treatment agent according to claim 1.

13. A concrete which is treated with the surface treatment agent according to claim 1.
